(19) United States
(12) Patent Application Publication
(10) Pub. No.: US 2022/0089468 A1
(43) Pub. Date: Mar. 24, 2022

(54) LOW-PRESSURE DISTRIBUTION SYSTEM AND METHOD

(71) Applicant: 11814192 CANADA INC., Sherbrooke, Quebec (CA)

(72) Inventors: Benoit Boucher, Sherbrooke, Quebec (CA); Francois R. Cote, La Prairie, Quebec (CA)

(73) Assignee: Robert Legal Brouillette, Montréal (CA)

(21) Appl. No.: 17/046,056

(22) PCT Filed: May 5, 2020
(86) PCT No.: PCT/CA2020/050597

§ 371 Date: Oct. 8, 2020

Related U.S. Application Data
(60) Provisional application No. 62/861,074, filed on Jun. 13, 2019.

(51) Int. Cl. C02F 3/28; C02F 3/04

(52) U.S. Cl. CPC C02F 3/288; E03F 1/002; C02F 3/046; C02F 3/043

(57) ABSTRACT

A low-pressure distribution system configured to pressurize effluent and distribute it throughout pressure conduits disposed within drainage conduits. The low-pressure distribution system may pressurize the effluent such that it is dispersed along a substantial portion or the entirety of the length of the pressure conduits and/or drainage conduits. To that end, the low-pressure distribution system may ensure an efficient distribution of the effluent throughout the drainage conduits while retaining an effluent flow rate therein suitable for the growth of microbial water treating bacteria.

### CROSS-REFERENCE TO RELATED APPLICATIONS

The present patent application claims the benefits of priority of U.S. Patent Application No. 62/861,074, entitled “LOW-PRESSURE DISTRIBUTION SYSTEM” and filed at the United States Patent and Trademark Office on Jun. 13, 2019, the content of which is incorporated herein by reference.

### FIELD OF THE INVENTION

The present invention generally relates to the field of wastewater and sewage treatment. More particularly, the present invention generally relates to a low-pressure distribution system for use in passive septic systems. As such, the device is configured to efficiently distribute effluent over the entire surface of a drainage field.

### BACKGROUND OF THE INVENTION

In the field of wastewater treatment, traditional septic systems rely on gravity to move the wastewater throughout the system and into the drain field. However, in cases where the gravity-fed systems may not operate effectively, low-pressure distribution systems have been used as an alternative to eliminate problems such as clogging of the soil from localized overloading or to address the ineffectiveness of traditional septic systems in systems requiring long travel distances or topographical installation sites providing gravitational challenges.

To that end, low-pressure distribution systems rely on pumping systems to pressurize the wastewater in order to achieve a controlled and uniform distribution of the wastewater across the drainage pipes. However, current low-pressure distribution systems limit the effectiveness of microbial water treating bacteria located within the drainage pipe by creating a pressurized flow rate which is not suitable for their growth.

There is therefore a need for a low-pressure distribution system capable of providing the advantages typically reserved to these systems while allowing a suitable growth of microbial water treating bacteria for an effective treatment of the wastewater.

### SUMMARY OF THE INVENTION

The present invention is directed to a wastewater treatment system comprising a tank, one or more drainage conduits and a low-pressure distribution system, wherein the low-pressure distribution system comprises a pumping system and one or more conduits disposed within the one or more drainage conduits, wherein the pumping system automatically doses pressurized wastewater into the one or more pressure conduits.

In another aspect of the invention, the one or more pressure conduits define a first portion longitudinally extending from an upstream end and a second portion longitudinally extending from a downstream end, and wherein the arrangement of the perforations along the first portion differs from the arrangement of the perforations along the second portion.

The present invention is further directed to a method of treating wastewater within a wastewater treatment system comprising a tank, one or more drainage conduits a pumping system and one or more pressure conduits disposed within the one or more drainage conduits in that the method comprises the steps of receiving the wastewater into a pumping system, pressurizing the wastewater, distributing or automatically dosing the wastewater across a portion of the one or more pressure conduits and releasing the wastewater from the pressure conduits into the drainage conduits along a portion of the one or more pressure conduits. The wastewater is further released from the pressure conduits in a first direction along a first portion of the one or more pressure conduits and in a second direction along a second portion of the one or more pressure conduits

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a side view of an embodiment of a wastewater treatment system for the decontamination and processing of liquid waste in accordance with the principles of the present invention;

FIG. 2 is a cross-sectional view of an exemplary septic tank used in the system of FIG. 1.

FIG. 3 shows a side perspective view of an exemplary of a drainage field used in the system of FIG. 1.

FIG. 4 is a top perspective view of the drainage field of FIG. 3.

FIG. 5 is a cross-sectional view of an exemplary pumping system used in the system of FIG. 1.

FIG. 6 is a cross-sectional view of an exemplary drainage conduit and pressure conduit used in the system of FIG. 1.

FIG. 7 is a cross-sectional view of an exemplary drainage field used in the system of FIG. 1.

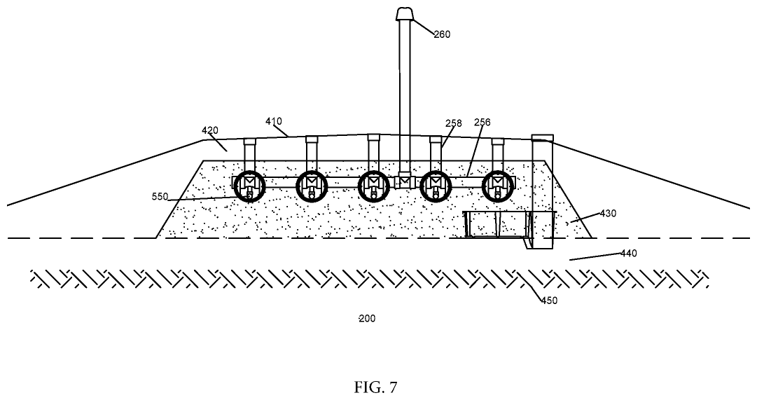

### DETAILED DESCRIPTION OF THE PREFERRED EMBODIMENT

A novel low-pressure distribution system and method will be described hereinafter. Although the invention is described in terms of specific illustrative embodiments, it is to be understood that the embodiments described herein are by way of example only and that the scope of the invention is not intended to be limited thereby.

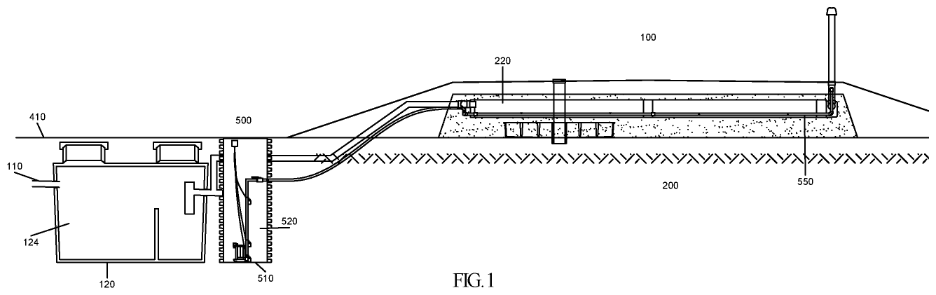

Referring now to FIG. 1, an embodiment of a wastewater treatment system 100 for the decontamination and processing of liquid waste is illustrated. The wastewater treatment system 100 typically comprises an input source, such as an input source or drainage pipe 110, a tank 120, such as a septic tank, and a drainage field 200.

The drainage pipe 110 may be configured to deliver wastewater to the wastewater treatment system 100 from a water consuming environment (such as a residential dwelling, a commercial space, an industrial space, etc.), typically in areas that are not connected to a municipal or urban sewage system such as, but not limited to, rural areas. The wastewater may comprise any water used from domestic, industrial, commercial or agricultural activities or any combination thereof.

Still referring to FIG. 1, in some embodiments, the drainage pipe 110 may be fluidly connected to the septic tank 120. The septic tank 120 may comprise an underground chamber 124 configured as a water-tight container generally made of concrete, fiberglass, plastic or any other suitable material known in the art. The underground chamber 124 may be either partially or entirely buried underneath a surface 410, such as a finished ground surface.

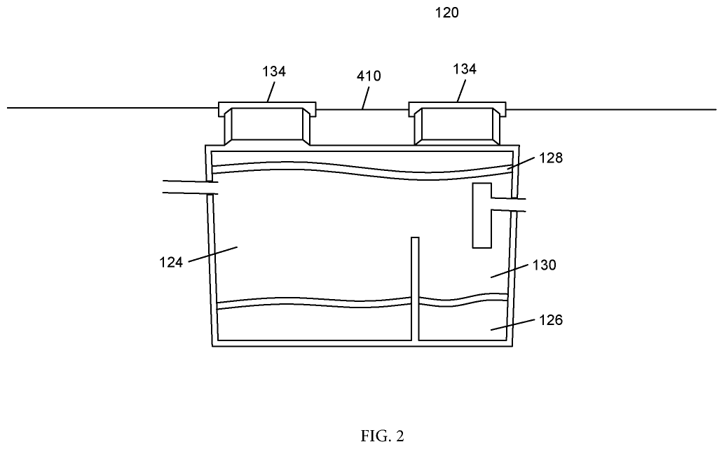

Referring now to FIG. 2, in some embodiments, the flow of wastewater within the septic tank 120 may be slow enough to allow for settling. Such flow of wastewater may further allow anaerobic processes to take place as a primary treatment of the wastewater. The settling process occurring within the underground chamber 124 will usually allow for solids and heavier particles disposed within the wastewater to settle to the bottom of the underground chamber 124 to form a layer of sludge 126. The septic tank 120 may further comprise microbes adapted to break down the sludge 126 by means of an anaerobic digestion into high molecular weight hydrocarbons, methane, hydrogen sulfide and sulfur dioxide gases. The microbes disposed within the septic tank 120 may include, but are not limited to, bacteria, fungi, algae, protozoa, rotifers and nematodes.

The settling process occurring within the underground chamber 124 may further allow separation of oils and grease from the wastewater, such as allowing said oils and grease to rise or float above the other components of the wastewater and to form a layer of scum 128. The scum 128 may further comprise other particles which are less dense than water including, but not limited to, soap scum, hair and paper products such as facial tissues.

In some embodiments, the remaining components of the wastewater which have not settled to the bottom underground chamber 124 to form a part of the layer of sludge 126 or risen to form a part of the layer of scum 128 may form a third intermediate layer of effluent 130, thereby providing a first treatment of the wastewater.

In further embodiments, the septic tank 120 may further comprise one or more access hatches for accessing the underground chamber 124. For example, in the embodiment shown in FIG. 2, the septic tank 120 comprises two access hatches 134. The access hatch 134 may be positioned above the surface 410 or below the surface 410 and accessible with little or no digging. The access hatch 134 may allow access to the underground chamber 124 to allow for drainage of the accumulation of the scum 128 and the sludge 126 which has not been decomposed by anaerobic digestion or for any other general maintenance of the septic tank 120.

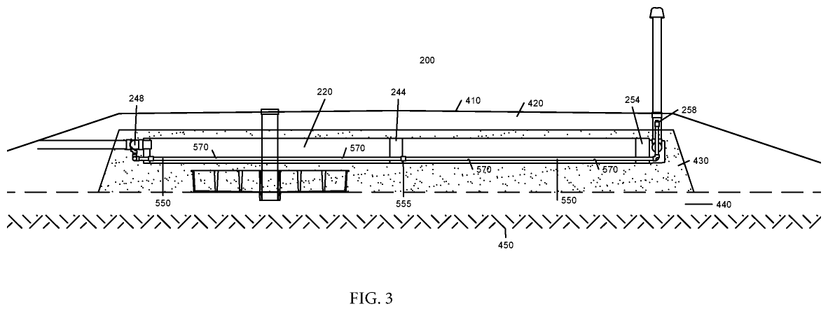

Referring now to FIGS. 1 and 3, in some embodiments, the septic tank 120 may be fluidly connected to one or more drainage fields 200 configured to receive and treat the effluent 130 from the septic tank 120 into treated wastewater. For example, in the embodiment shown in FIG. 1, the wastewater treatment system 100 comprises a drainage field 200 configured to treat the effluent 130.

Now referring to FIG. 3, the drainage field 200 may comprise a leach system 220 disposed between a plurality of ground layers. In such embodiment, the drainage field 200 comprises a surface 410, a covering layer 420 immediately below the surface 410, a filtering medium 430, a permeable soil 440 and a bedrock 450. In some embodiments, one or more of the layers may overlap and combine thereby removing any clear delineation between them.

In some embodiments, the leach system 220 may be at least partially surrounded by the filtering medium 430. In yet other embodiments, a portion of the filtering medium 430 may be disposed above the leach system 220 and/or another portion of the filtering medium 430 may be disposed underneath the leach system 220.

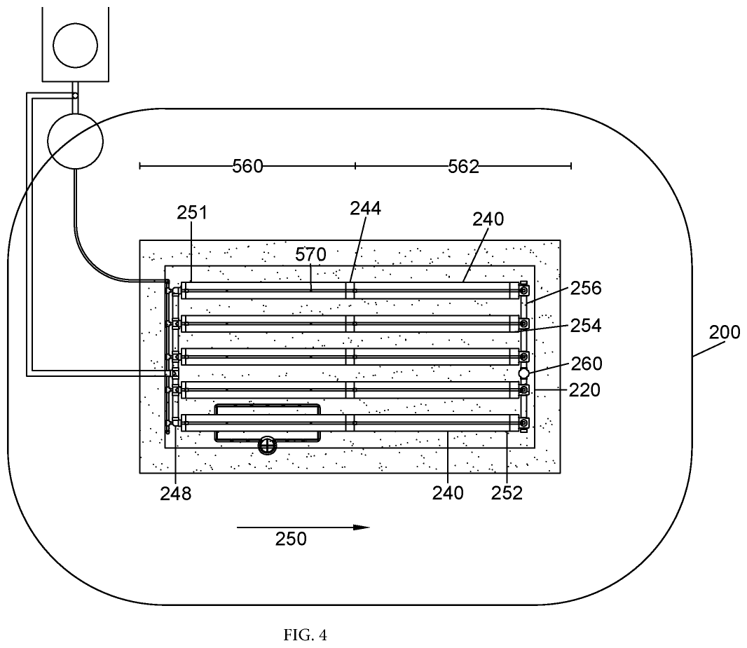

Now referring to FIG. 4, in some embodiments, the leach system 220 may comprise one or more drainage passages or conduits 240 configured to fluidly receive and treat the effluent 130. The drainage conduits 240 may comprise pipes configured to carry and distribute the effluent 130 across the drainage field 200. In some embodiments, the pipes may be perforated pipes. The effluent 130 flowing in the drainage conduits 240 may be conveyed by gravitational forces in tandem with the geometry of the drainage conduits 240.

The drainage conduits 240 may have any cross-sectional shape adapted to accommodate the volume of water to be disposed supplied by the drainage pipe 110 and/or to accommodate the topographic requirements of the installation site. For example, in the present embodiment, the drainage conduits 240 are circular. It may be appreciated that the drainage conduits 240 may have any other cross-sectional shape known in the art.

The drainage conduits 240 may be made of any semi rigid material. Examples of possible construction materials include, but are not limited to, plastics such as polypropylene and polyethylene or flexible metal. Other polymers, fibrous material, metal, rubber or rubber-like materials may also be used.

In yet other embodiments, the drainage conduits 240 may have any length or cross-sectional area suitable to accommodate the volume of water to be disposed supplied by the drainage pipe 110 and/or to accommodate the topographic requirements of the installation site. In some embodiments, the drainage conduits 240 may have a cross-sectional area of 175 cm² to 2,000 cm².

In some further embodiments, the drainage conduits 240 may be configured in parallel, in series or of combination thereof, such as with some drainage conduits 240 being positioned in parallel and other drainage conduits 240 being positioned in series. When configured in series, the drainage conduits 240 may be interconnected by means of couplers 244 configured to allow a fluid communication between two or more drainage conduits 240. When configured in parallel, the drainage conduits 240 may be interconnected by means of a distribution device 248 configured to distribute the effluent 130 across the two or more interconnected drainage conduits 240.

In yet other embodiments, the drainage conduits 240 may comprise microbes. The microbes may allow an aerobic process to treat the effluent 130 disposed within the drainage conduits 240 by absorbing the organic waste, removing pathogens and breaking down the effluent 130 into soluble by-products. In an embodiment, the drainage conduits 240 are adapted to encourage the development of microbial water treating bacteria responsible for a secondary treatment of the wastewater. In particular, the drainage conduits 240 may be adapted to maintain a controlled flow rate of the effluent 130 suitable for the growth of microbial water treating bacteria and may be geometrically configured to form spaces suitable for the growth of microbial water treating bacteria.

The drainage conduits 240 may further be corrugated to increase the structural flexibility and structural strength of said drainage conduits 240. Understandably, the corrugation of the drainage conduits 240 may further encourage the growth of microbial cultures and may provide a greater surface area for the development of microbial water treating bacteria and increases the contact surface between the microbial water treating bacteria and the effluent 130.

Still referring to FIG. 4, the flow of the effluent 130 within the drainage conduits 240 further defines a stream direction 250 wherein the beginnings of the drainage conduits 240 in the direction of the stream direction 250 are defined as upstream ends 251 and the ends of the drainage conduits 240 in the direction of the stream direction 250 are defined as downstream ends 252. In some embodiments, the downstream ends 252 of the drainage conduits 240 are configured to receive one or more end caps 254 which may be detachably affixed to the drainage conduits 240 and may either partially or entirely limit the flow of the effluent 130 outside of the downstream ends 252.

In some embodiments, the leach system 220 may comprise a junction pipe 256 configured to fluidly connect the one or more drainage conduits 240 at their downstream ends 252. To that end, the junction pipe 256 may comprise any shape and length necessary to reach the downstream ends 252 of the drainage conduits 240. In some embodiments, the end caps 254 may comprise an opening configured to allow fluid access to the junction pipe 256.

The leach system 220 may further comprise one or more piezometers 258 configured to measure and indicate the volume of the effluent 130 disposed within the drainage conduits 240. It may be appreciated that a high volume of the effluent 130 within the drainage conduits 240 may represent a malfunctioning of the wastewater treatment system 100. In such embodiment, the leach system 220 comprises a piezometer 258 connected to the junction pipe 256 with a gauge located above the surface 410. The location of the piezometer 258 generally aims at easing inspection by a user, such as a trained individual.

The leach system 220 may additionally comprise one or more vents 260 configured to allow the circulation of air within the drainage conduits 240. The air generally improves the aerobic treatment processes performed by the microbial water treating bacteria. In such an embodiment, the leach system 220 comprises a vent 260 fluidly connected to the junction pipe 256 with an opening located above the finished ground surface 410 allowing access to the outside air or atmosphere.

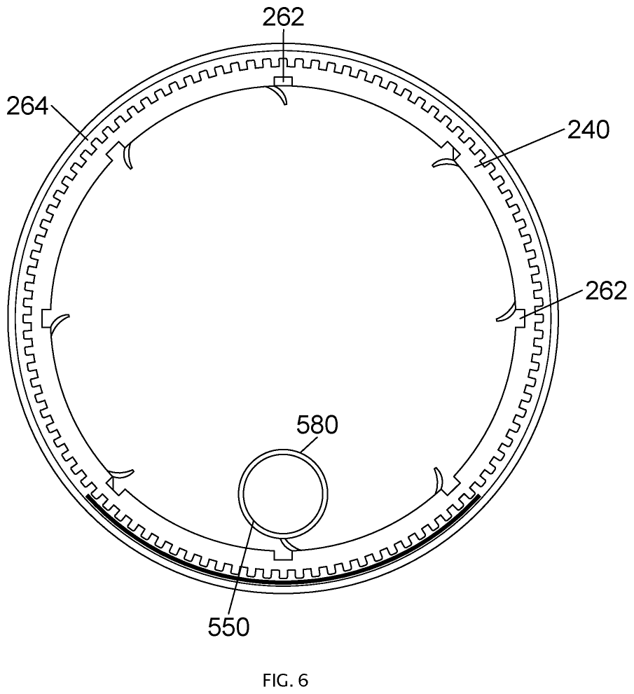

In a further embodiment and as illustrated in FIG. 6, the drainage conduits 240 may further comprise perforations 262 adapted to allow a release of the effluent 130 outside of the drainage conduits 240. In a preferred embodiment, the size of the perforations 262, the number of perforations 262 and the distribution of perforations 262 are determined based on the conditions of operation. As an example, the characteristics of the perforations may be determined to ensure a steady release of the effluent 130, to ensure leaching into the surrounding layers of the drainage field 200 and to distribute the effluent 130 along a substantial portion of the drainage conduits 240 in response to the volume of water to be disposed by the wastewater treatment system 100. It may be appreciated that a high number of perforations or perforations having large apertures may cause an undesirable amount of the effluent 130 to be released early on in the drainage conduits 240 as defined by the stream direction 250. Having too many perforation apertures or having large apertures may limit the longitudinal distribution of the effluent 130 to a first section of the drainage conduits 240. Similarly, a number of perforations being too low or perforations having small apertures may prevent a sufficient volume of the effluent 130 to be released from the conduits 240. In some embodiments, having an insufficient release of effluent 130 may cause an undesirable accumulation of the effluent 130 in the drainage conduits 240 or flooding of the drainage conduits 240 and the wastewater treatment system 100.

Still referring to FIG. 4, the leach system 220 may further comprise one or more layers of porous or filtering membranes 264, such as fabric membranes, adapted to wrap the drainage conduits 240 and to facilitate the leaching of the effluent 130 into the filtering medium 430. The membranes 264 may comprise any suitable synthetic media for the leaching of fluids. The membranes 264 may further facilitate the fixation of microbial water treating bacteria supporting treatment of the effluent 130. The membranes 264 may further support a longitudinal distribution of the effluent 130 along the drainage conduits 240.

The effluent 130 released from the leach system 220 may be absorbed by the filtering medium 430 enveloping the leach system 220. In some embodiments, the filtering medium 430 may be adapted to neutralize pollutants disposed within the effluent 130 percolating throughout the filtering medium 430, thereby providing a third treatment of the wastewater. These pollutants may include, but are not limited to, pathogens, nitrogen, phosphorous or any other contaminants. The filtering medium 430 may further comprise sand, organic matter (i.e. peat, sawdust) or any other suitable medium or combination known in the art capable of removing or neutralizing pollutants.

Referring back to FIG. 3, the effluent 130 treated by microbial water treating bacteria within the leach system 220 and filtered by the filtering medium 430 may be defined as treated wastewater.

As the treated wastewater exits the filtering medium 430, the treatment of the wastewater performed by the wastewater treatment system 100 is complete. The treated wastewater may disperse into the permeable soil 440 of the drainage field 200. In some embodiments, the permeable soil 440 of the drainage field 200 comprises a porous, unsaturated soil capable of absorbing fluids.

It may be appreciated that the topographical arrangement or soil composition of a particular drainage field 200 may not be suitable for the proper functioning of a wastewater treatment system 100. In particular and as illustrated in FIG. 1, certain drainage fields 200 may comprise denivelations which require the installation of a leach system 220 comprising drainage conduits 240 located at varying heights. Such exemplary arrangement may prevent the effective conveyance of the effluent 130 across the leach system 220 due solely to gravitational forces. Similarly, certain drainage fields 200 may comprise a filtering medium 430 or permeable soil 440 incapable of absorbing a continuous supply of the effluent 130 or treated wastewater. It may therefore be beneficial to allow dosing of the effluent 130 into the leach system 220.

Referring back to FIG. 1, in some embodiments, the wastewater treatment system 100 comprises a low-pressure distribution system 500 capable of providing a pressurized flow of the effluent 130 across the leach system 220. The low-pressure distribution system 500 typically comprises a pumping system 510. The pumping system 510 may be in fluid communication with the septic tank 120 and with the leach system 220. Understandably, the pumping system 510 may be installed at any other suitable location known in the art.

The pumping system 510 may comprise one or more pumping chambers 520 configured as a water-tight container generally made of concrete, fiberglass, plastic or any other suitable material known in the art. The pumping chamber 520 may be either partially or entirely buried underneath a surface 410, such as a finished ground surface.

In further embodiments, the pumping chamber 520 may further comprise one or more supply manifolds (not shown) for accessing the pumping chamber 520. The supply manifold (not shown) may be positioned above the surface 410 or below the surface 410 and accessible with little or no digging. The supply manifold may allow access to the pumping chamber 520 to allow for general maintenance or any other necessary or desired action.

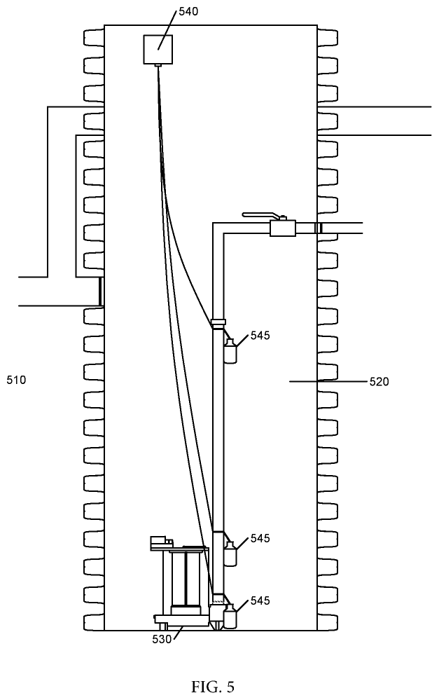

Referring now to FIG. 5, the pumping system 510 may further comprise a means for pressurizing the effluent 130. In certain embodiments, the means for pressurizing the effluent 130 may comprise an effluent pump 530. The effluent pump 530 may be disposed within the pumping chamber 520 or outside of the pumping chamber 520 while remaining in fluid communication with the pumping chamber 520. To that end, the effluent pump 530 may be configured to pressurize the effluent 130 contained within the pumping chamber 520 in order to obtain an effective distribution of the effluent 130 throughout the leach system 220. Understandably, the effluent pump 530 may comprise a positive displacement pump, a rotary pump, a gear pump, a screw pump or any other suitable pump known in the art.

It may be appreciated that the pumping chamber 520 comprises a finite volume for storing the effluent 130 before it is conveyed into the drainage field 200. In some further embodiments, the wastewater treatment system 100 may therefore comprise a means for determining the volume of effluent 130 contained within the pumping chamber 520. Determining the volume of effluent 130 within the pumping chamber 520 may allow the pumping system 510 to appropriately control the operation of the effluent pump 530, thus ensuring that the effluent pump 530 is not engaged without a minimum volume of effluent 130 necessary for the safe operation of the said effluent pump 530. Similarly, determining the volume of effluent may further indicate that the pumping chamber 520 does not contain a volume of effluent 130 which may cause said pumping chamber 520 to flood.

In some embodiments, the pumping system 510 may comprise a system to determine the volume of effluent 130 within the pumping chamber 520. The system for level identification 540 may further be configured to regulate the operation of the effluent pump 530. In such embodiment, the system 540 may regulate the volume of effluent 130 disposed within the pumping chamber 520 based on one or more predetermined levels of effluent 130 within the pumping chamber 520, a predetermined schedule, a combination thereof or any other known pump regulation method. Moreover, the level control 540 may be configured to activate, deactivate or regulate the operating speed of the effluent pump 530. It may be appreciated that the system for level identification 540 may regulate the operation of the effluent pump 530 to allow a dosing of the effluent 130 in accordance to the volume of effluent 130 requiring disposal and the absorption capabilities of the filtering medium 430 or permeable soil 440.

Still referring to FIG. 5, the system for level identification 540 may further comprise sensors 545. Sensors are configured to detect presence of the effluent and to send a signal to a controller (542). Depending on the signal received, the controller 542 may identify the level of effluent. In the illustrated embodiment, the pumping system 510 comprises three volume sensors 545 disposed at varying heights within the pumping chamber 520. In such embodiment, a first volume sensor 545 is positioned at a height equal to a minimum volume required for activating the effluent pump 530, a second volume sensor 545 is positioned at height equal to a preferred or desired volume for operating the effluent pump 530 and a third volume sensor 545 is positioned at a height equal to a maximum volume of effluent 130 allowable within the pumping chamber 520 which, when triggered, may automatically activate the effluent pump 530. The volume sensors 545 may further comprise a float sensor, a pneumatic sensor, a conductive sensor or any other suitable fluid sensor or liquid level sensor known in the art.

The system for level identification 540 generally comprises a controller 542 connected to or in communication with the one or more volume sensors 545 and with the pumping system 510. In some embodiments, the controller is configured to receive one or more signal from the volume sensor 545, to process the received signal and to control activation and deactivation of the pumping system 510 based on the identified volume of effluent in the pumping chamber 520. Understandably, the controller may be embodied as any type of controller known in the art, such as a computer, an electronic controller or a computerized device.

In some embodiments, the effluent pump 530 is configured to pressurize and discharge the effluent 130 into the drainage conduits 240 in order to provide an improved distribution of the effluent 130 along the length of the drainage conduits 240. In other embodiments however, it may be desirable to discharge the effluent 130 into smaller internal conduits capable of maintaining increased pressure levels further along the length of the drainage conduits 240.

Now referring to FIGS. 1, 3, 4 and 6, the low-pressure distribution system 500 may further comprise one or more pressure conduits 550 configured to distribute the effluent 130 along the drainage conduits 240. The pressure conduits 550 may be configured to be installed within the drainage conduits 240. The pressure conduits 550 may have any cross-sectional shape adapted to fit within the drainage conduits 240 and a cross-sectional area smaller than that of the drainage conduits 240. For example, in the present embodiment, the pressure conduits 550 are circular with a diameter which is less than that of the drainage conduits 240. It may be appreciated that the pressure conduits 550 may have any other cross-sectional shape known in the art. In certain embodiments, the pressure conduits 550 comprise a cross-sectional geometry suitable to ensure a pressurized flow of the effluent 130 along a substantial length or an entirety of the drainage conduits 240. In a preferred embodiment, the pressure conduits 550 may have a cross-sectional area of 6 cm² to 60 cm².

The pressure conduits 550 may be made of any semi rigid material. Examples of possible construction materials include, but are not limited to, plastics such as polypropylene and polyethylene or flexible metal. Other polymers, fibrous material, metal, rubber or rubber-like materials may also be used.

Referring to FIG. 3, multiple pressure conduits 550 may be serially disposed within one or more drainage conduits 240. Understandably, the pressure conduits 550 may be interconnected by means of couplers 555 or any connecting means configured to allow a fluid communication between two or more pressure conduits 550.

In certain embodiments, the pressure conduits 550 may be disposed along the bottom of the drainage conduits 240 and resting on the inner surfaces of the drainage conduits 240. In other embodiments, the pressure conduits 550 may be suspended or supported by support structures (not shown) such that they are partially or entirely disjoined from the drainage conduits 240. In yet other embodiments, the pressure conduits 550 may be affixed at any position along the inner circumference of the drainage pipes 240 using cables, straps, tie wraps or any other known means of attaching a pipe to a surface.

In certain embodiments, the pressure conduits 550 may comprise pipes which are perforated 570 and are adapted to allow a release of the effluent 130 outside of the pressure conduits 550 but within the drainage conduits 240. In a preferred embodiment, the size of the perforations 570, the number of perforations 570 and the distribution of perforations 570 are determined based on the conditions of operation. As an example, the characteristics of the perforations may be determined to ensure a steady release of the effluent 130, to ensure an even distribution of the effluent 130 along a substantial length of the drainage conduits 240 in response to the volume of water to be disposed by the wastewater treatment system 100. It may be appreciated that a high number of perforations or perforations having large apertures may cause an undesirable amount of the effluent 130 to be released early on in the pressure conduits 550 as defined by the stream direction 250. Having too many perforation apertures or having large apertures may limit the longitudinal distribution of the effluent 130 to a first section of the drainage conduits 240. Similarly, a number of perforations 570 being too low or perforations 570 having small apertures may prevent a sufficient volume of the effluent 130 to be released from the pressure conduits 550. In some embodiments, having an insufficient release of effluent 130 may cause an undesirable accumulation of the effluent 130 in the pressure conduits 550 or flooding of the pressure conduits 550 and the pumping chamber 520. The perforations 570 may be disposed along the circumference of pressure conduits 550 in any suitable position including the top, the bottom, the sides, at an angle, any combination thereof or in any other configuration known in the art.

In certain embodiments, one or more pressure conduits 550 may define two or more portions wherein each portion comprises a different arrangement of the perforations 570. In the example embodiment illustrated in FIG. 4, the pressure conduits 550 define a first portion 560 longitudinally extending in the stream direction 250 from the upstream end 251 and a second portion 562 longitudinally extending in a direction opposite from the stream direction 250 from the downstream end 252. The first portion 560 and second portion 562 may be contiguous or, in other embodiments, there may exist additional portions separating the first and second portions. It may be appreciated that the pressure of the effluent 130 dispersed within the first portion 560 may be higher than the pressure of the effluent 130 dispersed within the second portion 562 as effluent 130 is released from the pressure conduits 550 into the drainage conduits 240 by means of the perforations 570.

In further embodiments, the arrangement of the perforations 570 on the pressure conduits 550 may vary along the stream direction 250. For example, the perforations 570 may be disposed in a first manner along the first portion 560 and in a second manner along the second portion 562. Referring to FIG. 3, the perforations 570 may be disposed on the top of the pressure conduits 550 along the first portion 560 and on the bottom of the pressure conduits 550 along the second portion 562.

Disposed in this manner, the perforations 570 along the first portion 560 of the pressure conduits 550 may allow for an upwards dispersal of the effluent 130 and effective dispersal of the effluent 130 across the inner surfaces of the drainage conduits 240 due to the pressure in the first portion 560 of the pressure conduits 550. It may be appreciated that a broader dispersal of the effluent 130 across a greater surface area may encourage an increased development of microbial water treating bacteria and treatment of the effluent 130.

Due to the lower pressure within the second portion 562 of the pressure conduits 550, the perforations 570 may be disposed on the bottom of the pressure conduits 550 along the second portion 562. Disposed in this manner, the perforations 570 along the second portion 562 may ensure a release of the effluent 130 from the pressure conduits 550 and into the drainage conduits 240 despite the lower pressure levels contained therein. In a preferred embodiment, the perforations 570 may have a cross-sectional area of about 1 mm² to 25 mm²

In some embodiments, the pressure conduits 550 may further comprise one or more layers of porous or filtering membranes 580, such as fabric membranes, adapted to wrap the pressure conduits 550 and to facilitate the leaching of the effluent 130 into the drainage conduit 240. The membranes 580 may comprise any suitable synthetic media for the leaching of fluids. The membranes 580 may further facilitate the fixation of microbial water treating bacteria supporting treatment of the effluent 130. The membranes 580 may further support a longitudinal distribution of the effluent 130 along the outer surfaces of the pressure conduits 550.

In such embodiment, the presence of the pressure conduits 550 within the drainage conduits 240 may increase the allowable surface area for the growth of microbial water treating bacteria and increases the contact surface between the microbial water treating bacteria and the effluent 130.

In another embodiment, the pressure of the effluent 130 within the pressure conduits 550 may be high enough to project the effluent 130 in the form of a stream of fluid or jet as the effluent passes through the perforations 570 and into the drainage conduits 240. In some embodiments, the pressure of the effluent 130 within the pressure conduits 550 expressed in total dynamic head may be between 1 and 3 meters. The stream of fluid may be projected in a radial direction away from the pressure conduits 550. In yet another embodiment, the effluent 130 projected in the form of a stream of fluid may dissipate into droplets before impacting the inner walls 242 of the drainage conduits 240. It may be appreciated that projecting the effluent 130 in the form of a stream of fluid and further dissipating the effluent 130 into droplets may ensure a greater distribution of the effluent 130 across the inner walls 242 of the drainage conduits 240. As such, the low-pressure distribution may therefore increase the aerobic processing of the effluent 130 by allowing a larger number of microbial water treating bacteria to treat the effluent 130, thereby improving the secondary treatment of the effluent 130.

In some embodiments, the low-pressure distribution system 500 may further comprise a pressurized cleansing system 590 configured to allow a cleansing of the low-pressure distribution system 500. To that end, the pressurized cleansing system 590 may allow a user to introduce pressurized fluid into the low-pressure distribution system 500 in the event that a pressure conduit 550 becomes clogged or as part of general maintenance. In certain embodiments, the pressurized cleansing system 590 may comprise an inlet 592 allowing pressurized fluid to be introduced into the low-pressure distribution system 500. The inlet 592 may comprise a valve for attaching a pressurized hose or any other pressurized fluid attachment system known in the art. The pressurized cleansing system 590 may further comprise a release valve 594 configured to release pressurized fluid from the low-pressure distribution system such as to avoid a flooding of the drainage field 200. In certain embodiments, the release valve 594 may be located above the surface 410 and in fluid communication with a fluid collection device (not shown) configured to collect the pressurized fluid. The release valve 594 may be manually operated or automatically opened upon detection of a predetermined pressure level within the low-pressure distribution system 500.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A wastewater treatment system comprising:
a reservoir adapted to receive wastewater;
one or more drainage conduits disposed under the ground; and
a low-pressure distribution system, the low-pressure distribution system comprising:
a pumping system in fluid communication with the reservoir;
one or more pressure conduits disposed within the one or more drainage conduits and fluidly connected to the pumping system, each of the one or more pressure conduits comprising apertures.

2) The wastewater treatment system of claim 1, wherein the pumping system is adapted to distribute the wastewater into the one or more pressure conduits.

3) The wastewater treatment system of claim 2, wherein the wastewater distributed by the pumping system is pressurized.

4) The wastewater treatment system of claim 1, wherein the pumping system automatically doses wastewater into the one or more pressure conduits.

5) The wastewater treatment system of claim 1, the apertures of the pressure conduits being perforations.

6) The wastewater treatment system of claim 5, wherein the one or more pressure conduits define a first portion longitudinally extending from an upstream end and a second portion longitudinally extending from a downstream end, and wherein the arrangement of the perforations along the first portion differs from the arrangement of the perforations along the second portion.

7) The wastewater treatment system of claim 1, wherein the pressure conduits are arranged in series.

8) The wastewater treatment system of claim 1, wherein the wastewater comprises effluent.

9) The wastewater treatment system of claim 1, wherein the one or more pressure conduits are wrapped a membrane.

10) A method of treating wastewater within a wastewater treatment comprising:
a) receiving the wastewater into a pumping system;
b) the pump system pressurizing the wastewater in a pressure conduit disposed within a drainage conduit;
c) distributing the wastewater across a portion of the pressure conduit; and
d) releasing the wastewater from the pressure conduit into the drainage conduit along a portion of the pressure conduit.

11) The method as claimed in claim 10, wherein the wastewater is released from the pressure conduits in a first direction along a first portion of the pressure conduit and in a second direction along a second portion of the pressure conduit.

12) The method as claimed in claim 10, wherein the method further comprises the step of automatically dosing the distribution of the wastewater.

13) The method as claimed in claim 12, wherein the method further comprises the step of determining the automatic dosing of the wastewater by means of a level control.

14) The method as claimed in claim 10, releasing the wastewater from the pressure conduit further comprising releasing some of the wastewater toward a top inner portion of the drainage conduit.

15) The method as claimed in claim 10, releasing the wastewater from the pressure conduit further comprising releasing some of the wastewater toward a lower inner portion of the drainage conduit.
